(19) United States
(12) Patent Application Publication
(10) Pub. No.: US 2018/0009960 A1
(43) Pub. Date: Jan. 11, 2018

(54) FIBER-REIMFORCED MOLDED BODIES MADE OF EXPANDED PARTICLE FOAM MATERIAL

(71) Applicant: BASF SE, Ludwigshafen (DE)

(72) Inventors: Holger RUCKDÄSCHEL, St. Martin (DE); Alexandre TERRENOIRE, Ludwigshafen (DE); Rene ARBTER, Freinsheim (DE); Bangaru SAMPATH, Ludwigshafen (DE); Peter GUTMANN, Karlsruhe (DE); Ragnar STOLL, Osnabrück (DE); Christophe Leon Marie HEBETTE, Singapore (SG); Robert STEIN, Altrip (DE)

(21) Appl. No.: 15/538,723

(22) PCT Filed: Dec. 15, 2015
(86) PCT No.: PCT/EP2015/079808

§ 371 Date: Jun. 22, 2017

(30) Foreign Application Priority Data
Dec. 22, 2014 (EP) 14199626.4

(51) Int. Cl. C08J 9/00; B29C 47/00; B29B 9/06; C08J 9/16; B32B 5/02; B32B 5/08; B32B 5/18; B32B 5/24; B32B 27/06; B29C 44/34; C08J 9/36; B29L 31/08; B29K 105/12; B29L 9/00

(52) U.S. Cl. CPC C08J 9/0085; B29C 44/3461; B29C 47/0042; B29B 9/065; C08J 9/0061; C08J 9/16; B32B 5/024; C08J 9/36; B32B 5/028; B32B 5/08; B32B 5/18; B32B 5/245; B32B 27/065; B32B 5/026; B29K 2105/12; B29L 2009/00; B29L 2031/08; B32B 2260/021; B32B 2266/08; B32B 2307/546; B32B 2307/718; B32B 2603/00; B32B 2607/00; C08J 2325/06; C08J 2371/10; C08J 2471/10; C08J 2425/06

(57) ABSTRACT

The present invention relates to a molding made of expanded bead foam, wherein at least one fiber (F) is partly within the molding, i.e. is surrounded by the expanded bead foam. The two ends of the respective fibers (F) that are not surrounded by the expanded bead foam thus each project from one side of the corresponding molding. The present invention further provides a panel comprising at least one such molding and at least one further layer (S1). The present invention further provides processes for producing the moldings of the invention from expanded bead foam or the panels of the invention and for the use thereof, for example as rotor blade in wind turbines.

The present invention relates to a molding made of expanded bead foam, wherein at least one fiber (F) is partly within the molding, i.e. is surrounded by the expanded bead foam. The two ends of the respective fibers (F) that are not surrounded by the expanded bead foam thus each project from one side of the corresponding molding. The present invention further provides a panel comprising at least one such molding and at least one further layer (S1). The present invention further provides processes for producing the moldings of the invention from expanded bead foam or the panels of the invention and for the use thereof, for example as rotor blade in wind turbines.

WO 2006/125561 relates to a process for producing a reinforced cellular material, wherein at least one hole extending from a first surface to a second surface of the cellular material is produced in the cellular material in a first process step. On the other side of the second surface of the cellular material, at least one fiber bundle is provided, said fiber bundle being drawn with a needle through the hole to the first side of the cellular material. However, before the needle takes hold of the fiber bundle, the needle is first pulled through the particular hole coming from the first side of the cellular material. In addition, the fiber bundle on conclusion of the process according to WO 2006/125561 is partly within the cellular material, since it fills the corresponding hole, and the corresponding fiber bundle partly projects from the first and second surfaces of the cellular material on the respective sides.

By the process described in WO 2006/125561, it is possible to produce sandwich-like components comprising a core of said cellular material and at least one fiber bundle. Resin layers and fiber-reinforced resin layers may be applied to the surfaces of this core, in order to produce the actual sandwich-like component. Cellular materials used to form the core of the sandwich-like component may, for example, be polyvinyl chlorides or polyurethanes. Examples of useful fiber bundles include carbon fibers, nylon fibers, glass fibers or polyester fibers.

However, WO 2006/125561 does not disclose that molded foams can also be used as cellular material for production of a core in a sandwich-like component. The sandwich-like components according to WO 2006/125561 are suitable for use in aircraft construction.

WO 2011/012587 relates to a further process for producing a core with integrated bridging fibers for panels made from composite materials. The core is produced by pulling the bridging fibers provided on a surface of what is called a “cake” made from lightweight material partly or completely through said cake with the aid of a needle. The “cake” may be formed from polyurethane foams, polyester foams, polyethylene terephthalate foams, polyvinyl chloride foams or a phenolic foam, especially from a polyurethane foam. The fibers used may in principle be any kind of single or multiple threads and other yarns.

The cores thus produced may in turn be part of a panel made from composite materials, wherein the core is surrounded on one or two sides by a resin matrix and combinations of resin matrices with fibers in a sandwich-like configuration. However, WO 2011/012587 does not disclose that molded foams can be used for production of the corresponding core material.

WO 2012/138445 relates to a process for producing a composite core panel using a multitude of longitudinal strips of a cellular material having a low density. A twin-layer fiber mat is introduced between the individual strips, and this brings about bonding of the individual strips, with use of resin, to form the composite core panels. The cellular material having a low density that forms the longitudinal strips, according to WO 2012/138445, is selected from balsa wood, elastic foams and fiber-reinforced composite foams. The fiber mats introduced in twin-layer form between the individual strips may, for example, be a porous glass fiber mat. The resin used as adhesive may, for example, be a polyester, an epoxy resin or a phenolic resin, or a heat-activated thermoplastic, for example polypropylene or PET. However, WO 2012/138445 does not disclose that it is also possible to use a molded foam as cellular material for the elongated strips. Nor is it disclosed that individual fibers or fiber bundles can be incorporated into the cellular material for reinforcement. According to WO 2012/138445, exclusively fiber mats that additionally constitute a bonding element in the context of adhesive bonding of the individual strips by means of resin to obtain the core material are used for this purpose.

GB-A 2 455 044 discloses a process for producing a multilayer composite article, wherein, in a first process step, a multitude of beads of thermoplastic material and a blowing agent are provided. The thermoplastic material is a mixture of polystyrene (PS) and polyphenylene oxide (PPO) comprising at least 20% to 70% by weight of PPO. In a second process step the beads are expanded, and in a third process step they are welded in a mold to form a closed-cell foam of the thermoplastic material to give a molding, the closed-cell foam assuming the shape of the mold. A layer of fiber-reinforced material is applied to the surface of the closed-cell foam in the subsequent process step, the attachment of the respective surfaces being conducted using an epoxy resin. However, GB-A 2 455 044 does not disclose that fiber material can be introduced into the core of the multilayer composite article.

An analogous process and an analogous multilayer composite article (to those in GB-A 2 455 044) is also disclosed in WO 2009/047483. These multilayer composite articles are suitable, for example, for use of rotor blades (in wind turbines) or as ship's hulls.

U.S. Pat. No. 7,201,625 discloses a process for producing foam products and the foam products as such, which can be used, for example, in the sports sector as a surfboard. The core of the foam product is formed by a molded foam, for example based on a polystyrene foam. This molded foam is produced in a special mold, with an outer plastic skin surrounding the molded foam. The outer plastic skin may, for example, be a polyethylene film. However, U.S. Pat. No. 7,201,625 also does not disclose that fibers for reinforcement of the material may be present in the molded foam.

U.S. Pat. No. 6,767,623 discloses sandwich panels having a core layer of molded polypropylene foam based on particles having a particle size in the range from 2 to 8 mm and a bulk density in the range from 10 to 100 g/L. In addition, the sandwich panels comprise two outer layers of fiber-reinforced polypropylene, with the individual outer layers arranged around the core so as to form a sandwich. Still further layers may optionally be present in the sandwich panels for decorative purposes. The outer layers may comprise glass fibers or other polymer fibers.

EP-A 2 420 531 discloses extruded foams based on a polymer such as polystyrene in which at least one mineral filler having a particle size of ≦10 μm and at least one nucleating agent are present. These extruded foams are notable for their improved stiffness. Additionally described is a corresponding extrusion process for producing such extruded foams based on polystyrene. The extruded foams may have closed cells.

WO 2005/056653 relates to molded foams formed from expandable polymer beads comprising filler. The molded foams are obtainable by welding prefoamed foam beads formed from expandable thermoplastic polymer beads comprising filler, the molded foam having a density in the range from 8 to 300 g/L. The thermoplastic polymer beads especially comprise a styrene polymer. The fillers used may be pulverulent inorganic substances, metal, chalk, aluminum hydroxide, calcium carbonate or alumina, or inorganic substances in the form of beads or fibers, such as glass beads, glass fibers or carbon fibers.

U.S. Pat. No. 3,030,256 relates to laminated panels which have been produced by using fibers to reinforce a core that has been produced from a foam or an expanded polymer. Materials described for the core are expanded and extruded polystyrene, and also phenols, epoxides and polyurethanes. For introduction of the fibers, a needle is used to produce a hole from the first side of the core to the second side of the core, and the same needle is used to pull a fiber bundle through the hole from the second side to the first side, such that the fiber bundle is partly within the core and partly projects from the first and second sides. The fiber material is introduced into the core at an angle of 0° relative to the thickness direction of the core.

The object underlying the present invention is that of providing novel fiber-reinforced moldings or panels.

This object is achieved in accordance with the invention by a molding made of expanded bead foam, wherein at least one fiber (F) is present with a fiber region (FB2) within the molding and is surrounded by the expanded bead foam, while a fiber region (FB1) of the fiber (F) projects from a first side of the molding and a fiber region (FB3) of the fiber (F) projects from a second side of the molding, where the fiber (F) has been introduced into the expanded bead foam at an angle α of 10° to 70° relative to the thickness direction (d) of the molding.

The present invention further provides a molding made from expanded bead foam, wherein at least one fiber (F) is present with a fiber region (FB2) within the molding and is surrounded by the expanded bead foam, while a fiber region (FB1) of the fiber (F) projects from a first side of the molding and a fiber region (FB3) of the fiber (F) projects from a second side of the molding.

The details and preferences which follow apply to both embodiments of the inventive molding made from expanded bead foam.

It is an advantageous feature of the moldings of the invention that, because of the use of expanded bead foams, low resin absorption with simultaneously good interfacial binding is found. This effect is important especially when the moldings of the invention are being processed further to give the panels of the invention.

A further improvement in binding with simultaneously reduced resin absorption is enabled in accordance with the invention by the fiber reinforcement of the expanded bead foams in the moldings of the invention or the panels that result therefrom. According to the invention, the fibers (individually or preferably in the form of fiber bundles) can advantageously be introduced into the expanded bead foam at first in dry form and/or by mechanical processes. The fibers or fiber bundles are not laid down flush with the respective molded foam surfaces, but with an excess, and hence enable improved binding or direct connection to the corresponding outer plies in the panel of the invention. This is the case especially when the outer ply applied to the molding of the invention, in accordance with the invention, is at least one further layer (S1), to form a panel. Preference is given to applying two layers (S1), which may be the same or different. More preferably, two identical layers (S1), especially two identical fiber-reinforced resin layers, are applied to opposite sides of the molding of the invention to form a panel of the invention. Such panels are also referred to as “sandwich materials”, in which case the molding of the invention can also be referred to as “core material”.

The panels of the invention are thus notable for low resin absorption in conjunction with good peel strength. Moreover, high strength and stiffness properties can be established in a controlled manner via the choice of fiber types and the proportion and arrangement thereof. The effect of low resin absorption is important because a common aim in the case of use of such panels (sandwich materials) is that the structural properties should be increased with minimum weight. In the case of use of fiber-reinforced outer plies, for example, as well as the actual outer plies and the sandwich core, the resin absorption of the core material makes a contribution to the total weight. However, the moldings of the invention or the panels of the invention can reduce the resin absorption, which can save weight and costs.

A further advantage of the moldings or panels of the invention is considered to be that the use of molded foams and the associated production makes it relatively simple to incorporate integrated structures such as slots or holes on the surfaces of the moldings and to process the moldings further. In the case of use of such moldings (core materials), structures of this kind are frequently introduced, for example, into curved structures (deep slots) for draping, for improvement of processability by liquid resin processes such as vacuum infusion (holes), and for acceleration of the processing operation mentioned (shallow slots).

Further improvements/advantages can be achieved in that the fibers are introduced into the expanded bead foam at an angle α in the range from 10° to 70° in relation to the thickness direction (d) of the expanded bead foam, more preferably of 30° to 50°. Generally, the introduction of the fibers at an angle of 0° to <90° is performable industrially.

Additional improvements/advantages can be achieved when the fibers are introduced into the expanded bead foam not only in a parallel manner, but further fibers are also introduced at an angle β to one another which is preferably in the range from >0 to 180°. This additionally achieves an improvement in the mechanical properties of the molding of the invention.

It is likewise advantageous when the (outer) resin layer in the panels of the invention is applied by liquid injection methods or liquid infusion methods, in which the fibers can be impregnated with resin during processing and the mechanical properties improved. In addition, cost savings are possible.

The term “closed surface” is understood in the context of the present invention to mean the following: The closed surface is evaluated by light microscope or electron microscope images. By image analysis, the area proportion of open foam cells relative to the total surface area is assessed. Foams with a closed surface are defined as: (1−area proportion of open foam cells)/total surface area>30%, preferably >50%, more preferably >80%, especially >95%.

The present invention is specified further hereinafter.

According to the invention, the molding comprises an expanded bead foam and at least one fiber (F).

Expanded bead foams are known as such to those skilled in the art. Suitable expanded bead foams are, for example, based on at least one polymer selected from polystyrene, polyphenylene oxide, a copolymer prepared from phenylene oxide, a copolymer prepared from styrene, polysulfone, polyether sulfone, polypropylene, polyethylene, polyamide, polycarbonate, polyacrylate, polylactic acid, polyimide, polyvinylidene difluoride or a mixture thereof. The polymer is preferably selected from polystyrene, polyphenylene oxide, a mixture of polystyrene and polyphenylene oxide, a copolymer prepared from styrene, a mixture of copolymers prepared from styrene, or a mixture of polycarbonate with other polymers. Also suitable as expanded bead foams are thermoplastic elastomers. Thermoplastic elastomers are known as such to those skilled in the art.

Polyphenylene oxide is preferably poly(2,6-dimethylphenylene ether), which is also referred to as poly(2,6-dimethylphenylene oxide).

Suitable copolymers prepared from phenylene oxide are known to those skilled in the art. Suitable comonomers for phenylene oxide are likewise known to those skilled in the art.

A copolymer prepared from styrene preferably has, as comonomer to styrene, a monomer selected from α-methylstyrene, ring-halogenated styrenes, ring-alkylated styrenes, acrylonitrile, acrylic esters, methacrylic esters, N-vinyl compounds, maleic anhydride, butadiene, divinylbenzene and butanediol diacrylate.

The polymer on which the expanded bead foam is based is more preferably polystyrene, a mixture of polystyrene and poly(2,6-dimethylphenylene oxide) or a styrene-maleic anhydride polymer (SMA).

The expanded bead foam of the molding can be produced by any processes known to those skilled in the art.

In a preferred embodiment, the expanded bead foam of the molding is produced by a process comprising the following steps I) to VI):
I) producing expandable polymer beads from the corresponding polymer in the presence of a blowing agent at elevated temperature, preferably as a polymer melt and/or by extrusion,
II) optionally cooling and/or expanding the blowing agent-laden expandable polymer beads, optionally with expansion of the polymer beads to prefoamed partly expanded polymer beads,
III) optionally performing a pelletization, preferably an underwater pelletization, of the expandable polymer beads,
IV) optionally prefoaming the expandable polymer beads and/or optionally the partly expanded polymer beads at elevated temperature in the range from 95 to 150° C., preferably in the range from 100 to 140° C. and more preferably in the range from 105 to 130° C., and/or at low pressures in the range from 1 to 5 bar, preferably in the range from 1.1 to 3.6 bar and more preferably in the range from 1.3 to 2.8 bar, in the presence of steam or of a steam/air mixture, to obtain expanded beads,
V) introducing the partly expanded polymer beads from step II) and/or the pelletized beads from step III) and/or the expanded beads from step IV) into a shaping mold,
VI) contacting the partly expanded polymer beads from step II) and/or the pelletized beads from step III) and/or the expanded beads from step IV) with steam at elevated pressure in the range from 1 to 25 bar, preferably in the range from 1.1 to 8 bar and more preferably in the range from 1.5 to 4 bar, and/or elevated temperature in the range from 100 to 220° C., preferably in the range from 102 to 170° C. and more preferably in the range from 110 to 140° C. in the shaping mold to obtain the moldings made of expanded bead foam.

The contacting with steam in step VI) can be effected, for example, by cross-steaming and/or by autoclave steaming.

Suitable blowing agents in step I) are in principle any blowing agents known to those skilled in the art. For example, the blowing agent may be selected from the group of the alkanes such as pentane or butane, the group of the alcohols such as ethanol, carbon dioxide, nitrogen, water and combinations of these.

In a further preferred embodiment, the beads for production of the expanded bead foam of the molding have been produced by a suspension process, a melt impregnation process, a melt expansion process or a tank expansion process.

These methods are known per se to the person skilled in the art.

For example, a suspension process comprises the following steps:
I1) producing expandable polymer beads from the corresponding polymer or polymer mixture in the presence of a blowing agent in a pressurized tank at elevated temperature, the production being effected during the polymerization of the corresponding polymer or polymer mixture,
II1) cooling and/or expanding the blowing agent-laden expandable polymer beads, optionally with expansion of the polymer beads to partly expanded polymer beads,
III1) prefoaming the expandable polymer beads and/or optionally the partly expanded polymer beads at elevated temperature and/or at low pressures in the presence of steam to obtain expanded beads,
IV1) introducing the expanded beads from step III1) into a shaping mold,
V1) contacting the expanded beads from step III1) with steam at elevated pressure and/or elevated temperature in the shaping mold to obtain the moldings made from expanded bead foam.

Production during the polymerization of the corresponding polymer or polymer mixture in process step I1) can be effected during all polymerizations known to those skilled in the art. For example, the production can be effected during the polymerization of the polymer or polymer mixture in a solvent proceeding from monomers that are insoluble in the solvent and/or without solvent proceeding from monomers that are in suspended form in the corresponding polymer or polymer mixture, and swell said polymer or polymer mixture and are then polymerized.

The temperature in process step I1) is preferably in the range from 50° C. to 400° C., more preferably in the range from 100° C. to 200° C., especially preferably in the range from 100° C. to 150° C., and/or the pressure in process step I1) is preferably in the range from 5 to 500 bar, more preferably in the range from 50 to 300 bar, especially preferably in the range from 100 to 200 bar.

In respect of the temperature and pressure in process step V1), the details and preferences described above for process step VI) are applicable.

A melt impregnation process comprises the following steps, for example:
I2) producing expandable polymer beads from the corresponding blowing agent-laden polymer melt through the presence of at least one blowing agent in the polymer melt during the extrusion process at high pressures and high temperatures,
II2) performing a pelletization at a melt die pressure in the range from 80 to 300 bar, preferably in the range from 130 to 200 bar, preferably performing an underwater pelletization of the expandable polymer beads at a temperature of the flowing water medium in the range from 15° C. to 80° C., more preferably in the range from 30° C. to 60° C. and especially preferably in the range from 40° C. to 50° C., and a pressure of the flowing water medium in the range from 1 to 25 bar, preferably in the range from 5 to 20 bar, especially preferably in the range from 8 to 15 bar, optionally with expansion of the polymer beads to give partly expanded polymer beads,
III2) prefoaming the expandable polymer beads and/or optionally the partly expanded polymer beads at elevated temperature and/or at low pressures in the presence of steam to obtain expanded beads,
IV2) introducing the expanded beads from step III2) into a shaping mold,
V2) contacting the expanded beads from step III2) with steam at elevated pressure and/or elevated temperature in the shaping mold to obtain the moldings made from expanded bead foam.

Process step I2) can take place in an extruder, in a static melt mixer, in a dynamic melt mixer, in a heat exchanger or in combinations thereof. The temperature during process step I2) is preferably in the range from 100 to 450° C., more preferably in the range from 150 to 300° C., especially preferably in the range from 150 to 280° C., and/or the pressure in process step I2) is preferably in the range from 40 to 300 bar, more preferably in the range from 75 to 250 bar and especially preferably in the range from 80 to 200 bar.

In respect of the temperature and pressure in process step V2), the details and preferences described above for process step VI) are applicable.

The melt expansion process typically comprises the following steps:
I3) producing expandable polymer beads from a blowing agent-laden polymer melt through the presence of at least one blowing agent in the polymer melt during the extrusion process at high pressures and high temperatures,
II3) expanding the blowing agent-laden polymer melt with expansion of the polymer melt optionally after prior cooling, optionally expanding through exit from a die versus atmospheric pressure or in a pelletizing chamber for underwater pelletization with a pressure of the flowing water medium in the range from 1 to 25 bar, preferably in the range from 5 to 20 bar, especially preferably in the range from 8 to 15 bar, and a temperature of the flowing water medium in the range from 15 to 80° C., more preferably in the range from 30 to 60° C., especially preferably in the range from 40 to 50° C.,
III3) pelletizing the expanded polymer melt to give expanded beads, optionally in the pelletization chamber,
IV3) introducing the expanded beads from step III3) into a shaping, mold,
V3) contacting the pelletized beads from step III3) with steam at elevated pressure and/or elevated temperature in the shaping mold to obtain the moldings made from expanded bead foam.

Process step I3) can take place in an extruder, in a static melt mixer, in a dynamic melt mixer, in a heat exchanger or in combinations thereof. The temperature during process step I3) is preferably in the range from 100 to 450° C., more preferably in the range from 150 to 300° C., especially preferably in the range from 150 to 280° C., and/or the pressure in process step I3) is preferably in the range from 40 to 300 bar, more preferably in the range from 75 to 250 bar and especially preferably in the range from 80 to 200 bar.

In respect of the temperature and pressure in process step V3), the details and preferences described above for process step VI) are applicable.

In one embodiment, the tank expansion process comprises the following steps:
I4) producing expandable polymer beads from the corresponding polymer in the presence of a blowing agent at elevated temperature in a pressurized tank, the corresponding polymer being in the form of preformed beads, of a mass to be polymerized or of an already polymerized mass,
II4) cooling and/or expanding the blowing agent-laden expandable polymer beads, optionally with expansion of the polymer beads to partly expanded polymer beads,
III4) introducing the partly expanded polymer beads from step II4) into a shaping mold,
IV4) contacting the partly expanded polymer beads from step II4) with steam at elevated pressure and/or elevated temperature in the shaping mold to obtain the moldings made from expanded bead foam.

The temperature during process step I4) is preferably in the range from 50 to 400° C., more preferably in the range from 100 to 250° C., especially preferably in the range from 140° C. to 200° C., and/or the pressure in process step I4) is preferably in the range from 5 to 400 bar, more preferably in the range from 40 to 200 bar and especially preferably in the range from 60 to 150 bar.

In respect of the temperature and pressure in process step IV4), the details and preferences described above for process step VI) are applicable.

In one embodiment of the present invention the expanded bead foam has a density in the range from 10 to 250 g/L, preferably in the range from 25 to 150 g/L and especially preferably in the range from 30 to 100 g/L.

The fiber (F) present in the molding is a single fiber or a fiber bundle, preferably a fiber bundle. Suitable fibers (F) are all materials known to those skilled in the art that can form fibers. For example, the fiber (F) is an organic, inorganic, metallic or ceramic fiber or a combination thereof, preferably a polymeric fiber, basalt fiber, glass fiber, carbon fiber or natural fiber, especially preferably a polyaramid fiber, glass fiber, basalt fiber or carbon fiber; a polymeric fiber is preferably a fiber of polyester, polyamide, polyaramid, polyethylene, polyurethane, polyvinyl chloride, polyimide and/or polyamide imide; a natural fiber is preferably a fiber of sisal, hemp, flax, bamboo, coconut and/or jute.

In a preferred embodiment, fiber bundles are used. The fiber bundles are composed of several single fibers (filaments). The number of single fibers per bundle is at least 10, preferably 100 to 100 000 and more preferably 300 to 10 000 in the case of glass fibers and 1000 to 50 000 in the case of carbon fibers, and especially preferably 500 to 5000 in the case of glass fibers and 2000 to 20 000 in the case of carbon fibers.

According to the invention, the at least one fiber (F) is present with a fiber region (FB2) within the molding and is surrounded by the expanded bead foam, while a fiber region (FB1) of the fiber (F) projects from a first side of the molding and a fiber region (FB3) of the fiber (F) projects from a second side of the molding.

The fiber region (FB1), the fiber region (FB2) and the fiber region (FB3) may each account for any desired proportion of the total length of the fiber (F). In one embodiment, the fiber region (FB1) and the fiber region (FB3) each independently account for 1% to 45%, preferably 2% to 40% and more preferably 5% to 30%, and the fiber region (FB2) for 10% to 98%, preferably 20% to 96% and more preferably 40% to 90%, of the total length of the fiber (F).

In a further preferred embodiment, the first side of the molding from which the fiber region (FB1) of the fiber (F) projects is opposite the second side of the molding from which the fiber region (FB3) of the fiber (F) projects.

The fiber (F) has been introduced into the molding at an angle α of 10° to 70° relative to thickness direction (d) of the molding or to the orthogonal (of the surface) of the first side (2) of the molding. Preferably, the fiber (F) has been introduced into the expanded bead foam at an angle α of 30° to 60°, preferably of 30° to 50°, even more preferably of 30° to 45° and especially of 45° relative to the thickness direction (d) of the molding.

In a further embodiment of the invention, the angle α can assume any desired values from 0° to 90°. For example, the fiber (F) in that case has been introduced into the expanded bead foam at an angle α of 0° to 60°, preferably of 0° to 50°, more preferably of 0° to 15° or of 30° to 50°, even more preferably of 30° to 45° and especially of 45° relative to the thickness direction (d) of the molding.

In a further embodiment, at least two fibers (F) are introduced at two different angles α, α, α₁ and α₂, where the angle α₁ is preferably in the range from 0° to 15° and the second angle α₂ is preferably in the range from 30 to 50°; especially preferably, α₁ is in the range from 0° to 5° and α₂ in the range from 40 to 50°.

Preferably, all fibers (F) have been introduced into the expanded bead foam at an angle α in the range from 10° to 70°, preferably from 30° to 60°, especially preferably from 30° to 50°, even more preferably from 30° to 45° and most preferably of 45° relative to the thickness direction (d) of the molding.

It is additionally preferable that no further fiber has been introduced into the expanded bead foam apart from the at least one fiber (F).

Preferably, a molding of the invention comprises a multitude of fibers (F), preferably as fiber bundles, and/or comprises more than 10 fibers (F) or fiber bundles per m², preferably more than 1000 per m², more preferably 4000 to 40 000 per m². Preferably, all fibers (F) in the molding of the invention have the same angle α or at least approximately the same angle (difference of not more than +/−5°, preferably +/−2°, more preferably +/−1°).

All fibers (F) may be present parallel to one another in the molding. It is likewise possible and preferable in accordance with the invention that two or more fibers (F) are present at an angle β to one another in the molding. The angle β is understood in the context of the present invention to mean the angle between the orthogonal projection of a first fiber (F1) onto the surface of the first side of the molding and the orthogonal projection of a second fiber (F2) onto the surface of the molding, both fibers having been introduced into the molding.

The angle β is preferably in the range of β=360°/n where n is an integer. Preferably, n is in the range from 2 to 6, more preferably in the range from 2 to 4. For example, the angle β is 90°, 120° or 180°. In a further embodiment, the angle β is in the range from 80° to 100°, in the range from 110° to 130° or in the range from 170° to 190°. In a further embodiment, more than two fibers (F) have been introduced at an angle β to one another, for example three or four fibers (F). These three or four fibers (F) may each have two different angles β, β₁ and β₂ to the two adjacent fibers. Preferably, all the fibers (F) have the same angles β=β, =β₂ to the two adjacent fibers (F). For example, the angle β is 90°, in which case the angle β₁ between the first fiber (F1) and the second fiber (F2) is 90°, the angle β₂ between the second fiber (F2) and third fiber (F3) is 90°, the angle β₃ between the third fiber and fourth fiber (F4) is 90°, and the angle β₄ between the fourth fiber (F4) and the first fiber (F1) is likewise 90°. The angles 13 between the first fiber (F1) (reference) and the second fiber (F2), third fiber (F3) and fourth fiber (F4) are then, in the clockwise sense, 90°, 180° and 270°. Analogous considerations apply to the other possible angles.

The first fiber (F1) in that case has a first direction, and the second fiber (F2) arranged at an angle β to the first fiber (F1) has a second direction. Preferably, there is a similar number of fibers in the first direction and in the second direction. “Similar” in the present context is understood to mean that the difference between the number of fibers in each direction relative to the other direction is <30%, more preferably <10% and especially preferably <2%.

The fibers or fiber bundles may be introduced in irregular or regular patterns. Preference is given to the introduction of fibers or fiber bundles in regular patterns. “Regular patterns” in the context of the present invention is understood to mean that all fibers are aligned parallel to one another and that at least one fiber or fiber bundle has the same distance (a) from all directly adjacent fibers or fiber bundles. Especially preferably, all fibers or fiber bundles have the same distance from all directly adjacent fibers or fiber bundles.

In a further preferred embodiment, the fibers or fiber bundles are introduced such that they, based on an orthogonal system of coordinates, where the thickness direction (d) corresponds to the z direction, each have the same distance from one another (aₓ) in the x direction and the same distance (a_{y}) in the y direction. Especially preferably, they have the same distance (a) in x direction and in y direction, where a=aₓ=a_{y}.

If two or more fibers (F) are at an angle β to one another, the first fibers (F1) that are parallel to one another preferably have a regular pattern with a first distance (a₁), and the second fibers (F2) that are parallel to one another and are at an angle β to the first fibers (F1) preferably have a regular pattern with a second distance (a₂). In a preferred embodiment, the first fibers (F1) and the second fibers (F2) each have a regular pattern with a distance (a). In that case, a=a₁=a₂.

If fibers or fiber bundles are introduced into the expanded bead foam at an angle (to one another, it is preferable that the fibers or fiber bundles follow a regular pattern in each direction.

In a preferred embodiment of the molding according to the present invention,
i) the surface of at least one side of the molding has at least one recess, the recess preferably being a slot or a hole, and at least one recess more preferably being produced on the surface of at least one side of the molding after the performance of step VI) of the process of the invention for producing a molding from expanded bead foam and/or
ii) the total surface area of the molding of the invention is closed to an extent of more than 30%, preferably to an extent of more than 50%, more preferably to an extent of more than 80%, especially more than 95%.

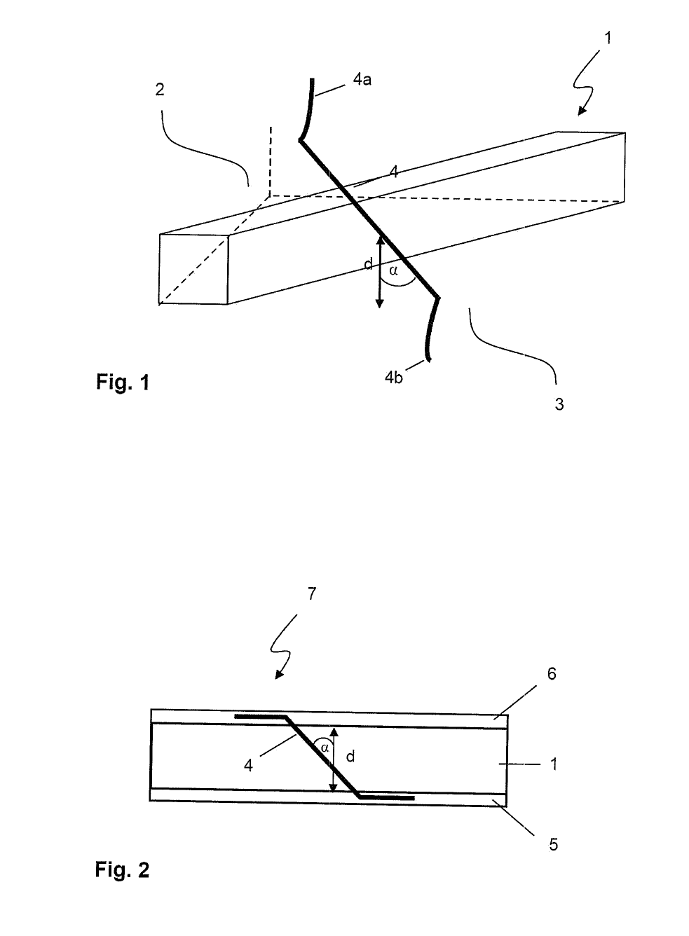

FIG. 1 shows a schematic diagram of a preferred embodiment of the molding of the invention made from expanded bead foam (1) in a perspective view. (2) represents (the surface of) a first side of the molding, while (3) represents a second side of the corresponding molding. As further apparent from FIG. 1, the first side (2) of the molding is opposite the second side (3) of this molding. The fiber (F) is represented by (4). One end of this fiber (4a) and hence the fiber region (FB1) projects from the first side (2) of the molding, while the other end (4b) of the fiber, which constitutes the fiber region (FB3), projects from the second side (3) of the molding. The middle fiber region (FB2) is within the molding and is thus surrounded by the expanded bead foam.

In FIG. 1, the fiber (4) which is, for example, a single fiber or a fiber bundle, preferably a fiber bundle, is at an angle α relative to thickness direction (d) of the molding or to the orthogonal (of the surface) of the first side (2) of the molding. The angle α is 10° to 70°, preferably 30° to 60°, more preferably 30° to 50°, even more preferably 30° to 45°, especially 45°. For the sake of clarity, FIG. 1 shows just a single fiber (F).

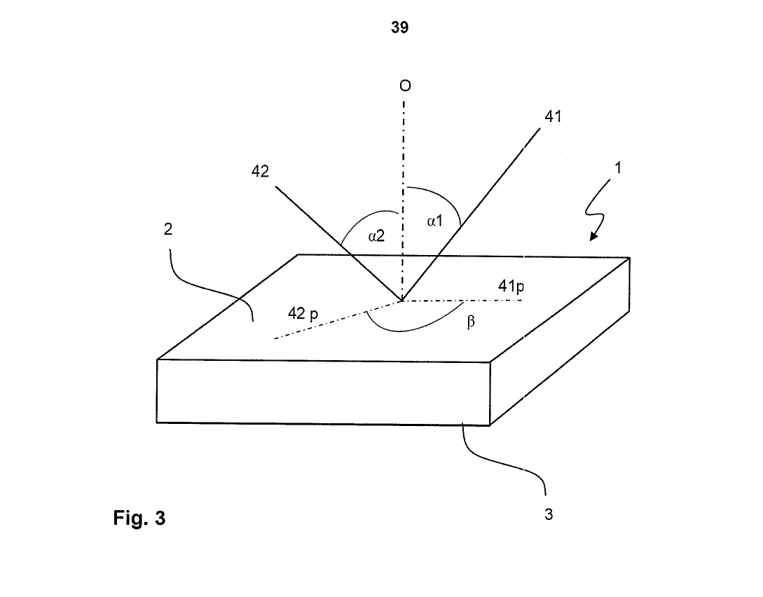

FIG. 3 shows, by way of example, a schematic diagram of the different angles. The molding made from expanded bead foam (1) shown in FIG. 3 comprises a first fiber (41) and a second fiber (42). In FIG. 3, for better clarity, only the fiber region (FB1) that projects from the first side (2) of the molding is shown for the two fibers (41) and (42). The first fiber (41) forms a first angle α (α1) relative to the orthogonal (O) of the surface of the first side (2) of the molding. The second fiber (42) forms a second angle α (α2) relative to the orthogonal (O) of the surface of the first side (2). The orthogonal projection of the first fiber (41) onto the first side (2) of the molding (41p) forms the angle β with the orthogonal projection of the second fiber (42) onto the first side of the molding (42p).

The present invention also provides a panel comprising at least one molding of the invention and at least one layer (S1). A “panel” may in some cases also be referred to among specialists as “sandwich”, “sandwich material”, “laminate” and/or “composite article”.

In a preferred embodiment of the panel, the panel has two layers (S1), and the two layers (S1) are each mounted on a side of the molding opposite the respective other layer in the molding.

In one embodiment of the panel of the invention, the layer (S1) comprises at least one resin, the resin preferably being a reactive thermoset or thermoplastic resin, the resin more preferably being based on epoxides, acrylates, polyurethanes, polyamides, polyesters, unsaturated polyesters, vinyl esters or mixtures thereof, and the resin especially being an amine-curing epoxy resin, a latently curing epoxy resin, an anhydride-curing epoxy resin or a polyurethane formed from isocyanates and polyols. Resin systems of this kind are known to those skilled in the art, for example from Penczek et al. (Advances in Polymer Science, 184, p. 1-95, 2005), Pham et al. (Ullmann's Encyclopedia of Industrial Chemistry, vol. 13, 2012), Fahnler (Polyamide, Kunststoff Handbuch ¾, 1998) and Younes (WO12134878 A2).

Preference is also given in accordance with the invention to a panel in which
i) the fiber region (FB1) of the fiber (F) is in partial or complete contact, preferably complete contact, with the first layer (S1), and/or
ii) the fiber region (FB3) of the fiber (F) is in partial or complete contact, preferably complete contact, with the second layer (S1), and/or
iii) the panel has at least one layer (S2) between at least one side of the molding and at least one layer (S1), the layer (S2) preferably being composed of two-dimensional fiber materials or polymeric films, more preferably of glass fibers or carbon fibers in the form of webs, scrims or weaves.

In a further inventive embodiment of the panel, the at least one layer (S1) additionally comprises at least one fibrous material, wherein
i) the fibrous material comprises fibers in the form of one or more laminas of chopped fibers, webs, scrims, knits and/or weaves, preferably in the form of scrims or weaves, more preferably in the form of scrims or weaves having a basis weight per scrim or weave of 150 to 2500 g/m², and/or
ii) the fibrous material comprises fibers of organic, inorganic, metallic or ceramic fibers, preferably polymeric fibers, basalt fibers, glass fibers, carbon fibers or natural fibers, more preferably glass fibers or carbon fibers.

The details described above are applicable to the natural fibers and the polymeric fibers.

A layer (S1) additionally comprising at least one fibrous material is also referred to as fiber-reinforced layer, especially as fiber-reinforced resin layer if the layer (S1) comprises a resin.

FIG. 2 shows a further preferred embodiment of the present invention. A two-dimensional side view of a panel (7) of the invention is shown, comprising a molding (1) of the invention, as detailed above, for example, within the context of the embodiment of FIG. 1. Unless stated otherwise, the reference numerals have the same meaning in the case of other abbreviations in FIGS. 1 and 2.

In the embodiment according to FIG. 2, the panel of the invention comprises two layers (S1) represented by (5) and (6). The two layers (5) and (6) are thus each on mutually opposite sides of the molding (1). The layers (5) and (6) are preferably resin layers or fiber-reinforced resin layers. As further apparent from FIG. 2, the two ends of the fibers (4) are surrounded by the respective layers (5) and (6).

It is optionally possible for one or more further layers to be present between the molding (1) and the first layer (5) and/or between the molding (1) and the second layer (6). As described above for FIG. 1, FIG. 2 also shows, for the sake of simplicity, a single fiber (F) with (4). With regard to the number of fibers or fiber bundles, in practice, analogous statements apply to those detailed above for FIG. 1.

The present invention further provides a process for producing the molding of the invention, wherein at least one fiber (F) is partly introduced into the expanded bead foam, as a result of which the fiber (F) is present with the fiber region (FB2) within the molding and is surrounded by the expanded bead foam, while the fiber region (FB1) of the fiber (F) projects out of a first side of the molding and the fiber region (FB3) of the fiber (F) projects out of a second side of the molding.

The present invention further provides a process for producing the molding of the invention, wherein at least one fiber (F) is partly introduced into the expanded bead foam, as a result of which the fiber (F) is present with the fiber region (FB2) within the molding and is surrounded by the expanded bead foam, while the fiber region (FB1) of the fiber (F) projects out of a first side of the molding and the fiber region (FB3) of the fiber (F) projects out of a second side of the molding, as a result of which the fiber (F) has been introduced into the expanded bead foam at an angle α of 10° to 70° relative to the thickness direction (d) of the molding.

Suitable methods of introducing the fiber (F) and/or a fiber bundle are in principle all those known to those skilled in the art. Suitable processes are described, for example, in WO 2006/125561 or in WO 2011/012587.

In one embodiment of the process of the invention, the at least one fiber (F) is partially introduced into the expanded bead foam by sewing it in using a needle. The partial introduction is preferably effected by means of steps a) to f):
a) optionally applying at least one layer (S2) to at least one side of the expanded bead foam,
b) producing one hole per fiber (F) in the expanded bead foam and in any layer (S2), the hole extending from a first side to a second side of the expanded bead foam and through any layer (S2),
c) providing at least one fiber (F) on the second side of the expanded bead foam,
d) passing a needle from the first side of the expanded bead foam through the hole to the second side of the expanded bead foam, and passing the needle through any layer (S2),
e) securing at least one fiber (F) on the needle on the second side of the expanded bead foam, and
f) returning the needle along with the fiber (F) through the hole, such that the fiber (F) is present with the fiber region (FB2) within the molding and is surrounded by the expanded bead foam, while the fiber region (FB1) of the fiber (F) projects from a first side of the molding or from any layer (S2) and the fiber region (FB3) of the fiber (F) projects from a second side of the molding,
   more preferably with simultaneous performance of steps b) and d).

In a particularly preferred embodiment, steps b) and d) are performed simultaneously. In this embodiment, the hole from the first side to the second side of the expanded bead foam is produced by the passing of a needle from the first side of the expanded bead foam to the second side of the expanded bead foam.

In this embodiment, the introduction of the at least one fiber (F) may comprise, for example, the following steps:
a) optionally applying a layer (S2) to at least one side of the expanded bead foam,
b) providing at least one fiber (F) on the second side of the expanded bead foam,
c) producing one hole per fiber (F) in the expanded bead foam and in any layer (S2), the hole extending from the first side to a second side of the expanded bead foam and through any layer (S2), and the hole being produced by the passing of a needle through the expanded bead foam and through any layer (S2),
d) securing at least one fiber (F) on the needle on the second side of the expanded bead foam,
e) returning the needle along with the fiber (F) through the hole, such that the fiber (F) is present with the fiber region (FB2) within the molding and is surrounded by the expanded bead foam, while the fiber region (FB1) of the fiber (F) projects from a first side of the molding or from any layer (S2) and the fiber region (FB3) projects from a second side of the molding,
f) optionally cutting off the fiber (F) on the second side and
g) optionally cutting open the loop of the fiber (F) formed at the needle.

In a preferred embodiment, the needle used is a hook needle and at least one fiber (F) is hooked into in the hook needle in step d).

In a further preferred embodiment, a plurality of fibers (F) are introduced simultaneously into the expanded bead foam according to the steps described above.

The present invention further provides a process for producing the panel of the invention, in which the at least one layer (S1) in the form of a reactive viscous resin is applied to a molding of the invention and cured, preferably by liquid impregnation methods, more preferably by pressure- or vacuum-assisted impregnation methods, especially preferably by vacuum infusion or pressure-assisted injection methods, most preferably by vacuum infusion. Liquid impregnation methods are known as such to those skilled in the art and are described in detail, for example, in Wiley Encyclopedia of Composites (2nd Edition, Wiley, 2012), Parnas et al. (Liquid Composite Moulding, Hanser, 2000) and Williams et al. (Composites Part A, 27, p. 517-524, 1997).

Various auxiliary materials can be used for production of the panel of the invention. Suitable auxiliary materials for production by vacuum infusion are, for example, vacuum film, preferably made from nylon, vacuum sealing tape, flow aids, preferably made from nylon, separating film, preferably made from polyolefin, tearoff fabric, preferably made from polyester, and a semipermeable film, preferably a membrane film, more preferably a PTFE membrane film, and absorption fleece, preferably made from polyester. The choice of suitable auxiliary materials is guided by the component to be manufactured, the process chosen and the materials used, specifically the resin system. In the case of use of resin systems based on epoxide and polyurethane, preference is given to using flow aids made from nylon, separation films made from polyolefin, tearoff fabric made from polyester, and a semipermeable films as PTFE membrane films, and absorption fleeces made from polyester.

These auxiliary materials can be used in various ways in the process for producing the panel of the invention. Panels are more preferably produced from the moldings by applying fiber-reinforced outer plies by means of vacuum infusion. In a typical construction, for production of the panel of the invention, fibrous materials and optionally further layers are applied to the upper and lower sides of the molding. Subsequently, tearoff fabric and separation films are positioned. In the infusion of the liquid resin system, it is possible to work with flow aids and/or membrane films. Particular preference is given to the following variants:
i) use of a flow aid on just one side of the construction and/or
ii) use of a flow aid on both sides of the construction and/or
iii) construction with a semipermeable membrane (VAP construction); the latter is preferably draped over the full area of the molding, on which flow aids, separation film and tearoff fabric are used on one or both sides, and the semipermeable membrane is sealed with respect to the mold surface by means of vacuum sealing tape, the absorption fleece is inserted on the side of the semipermeable membrane remote from the molding, as a result of which the air is evacuated upward over the full area and/or
iv) use of a vacuum pocket made from membrane film, which is preferably positioned at the opposite gate side of the molding, by means of which the air is evacuated from the opposite side to the gate.

The construction is subsequently equipped with gates for the resin system and gates for the evacuation. Finally, a vacuum film is applied over the entire construction and sealed with sealing tape, and the entire construction is evacuated. After the infusion of the resin system, the reaction of the resin system takes place with maintenance of the vacuum.

The present invention also provides for the use of the molding of the invention or of the panel of the invention for rotor blades in wind turbines, in the transport sector, in the construction sector, in automobile construction, in shipbuilding, in rail vehicle construction, for container construction, for sanitary installations and/or in aerospace.

The present invention is illustrated hereinafter by examples.

### EXAMPLE 1 (COMPARATIVE EXAMPLE, MOLDING MADE FROM EXPANDED BEAD FOAM WITHOUT FIBER REINFORCEMENT)

For all experiments according to example 1, bead foams based on blends of PPE and PS are used (mixture of PPE/PS masterbatch, Noryl C6850, Sabic and PS 158K, BASF). The expandable polymer beads were manufactured by a melt impregnation process with subsequent pressurized underwater pelletization.

### a) Production of the Expandable Polymer Beads

A twin-screw extruder with a screw diameter of 43 mm and a ratio of length to diameter of 44 is charged with 59.5 parts by weight of a PPE/PS blend (composition: 50% PPE, 50% PS) from Sabic (Noryl C6850), 40 parts by weight of a PS from BASF SE (PS 158 K Q4) and 0.5 parts by weight of talc from Mondo Minerals (Microtalc IT Extra) by metered addition. The aforementioned thermoplastic polymers are melted in the melting zone of the twin-screw extruder and mixed with the talc. After the thermoplastic polymers have melted and the talc has been mixed in, 4 parts by weight based on the amount of solids (polymer and talc) of a mixture of n-pentane and isopentane (80% by weight of n-pentane and 20% by weight of isopentane based on the total amount of pentane) and 0.3 part by weight, based on the amount of solids (polymer and talc), of nitrogen as blowing agent are added. In the course of passage through the rest of the extruder length, the blowing agent and the polymer melt are mixed with one another, so as to form a homogeneous mixture. The total throughput of the extruder comprising the polymers, talc and the blowing agent is 70 kg/h.

In the examples, the following process parameters are set: The extruder speed is set at 140 rpm. The extruder temperature in the melting zone and during the mixing of the talc into the polymers is between 230° C. and 240° C. The temperature at the extruder housing of the injection site is lowered down to 230° C. to 220° C., and of all subsequent housings as far as the end of the extruder down to 220° C. to 210° C. The melt pump and the start-up valve are kept at 210° C., and a downstream housing at 215° C. By means of the melt pump, a pressure at the end of the extruder of 85 bar is established. The temperature of the oil-heated perforated plate heated to a target temperature of 290° C.

For all examples, the mixture of polymer, talc and blowing agent is forced through the perforated plate having 50 holes having a diameter of 0.85 mm and chopped by 10 rotating blades secured to a blade ring in the downstream pelletizing chamber through which there was a flow of water. This produces beads having an average size of about 1.25 mm and a weight of about 1.1 mg. The pressure in the pelletizing chamber is 12 bar. The temperature-controlled medium is kept constant at 50° C. The process medium and the pellets/beads produced are subsequently separated in a rotary drier.

b) Production of the Moldings from Expanded Bead Foam

Subsequently, the expandable polymer beads are processed further to give moldings made from expanded bead foam. At a pressure of 1.2 bar over the course of 200 seconds, the particles are prefoamed at a stirrer speed of 60 rpm. This gives a bulk density of 49 kg/m³. Subsequently, the beads are stabilized at room temperature for 24 hours. The foam slabs are produced with a foam molding machine as rectangular slabs for experiments C1, C2 and C4. In addition, rectangular slabs with slots are produced (C3), which result from the molding tool (slot separation: 30 mm, orientation: longitudinal and transverse on one side of the slab, slot width: 2 mm, slot depth: 19 mm). Production is effected by cross-steaming at 1.5 bar for 10 seconds and autoclave steaming at 2.2 bar for 15 seconds. Thereafter, the foam block is cooled down and removed from the mold. The density of the blocks after 24 hours at room temperature is 50 g/L.

### c) Resin Absorption by the Moldings to Form a Panel

For the resin absorption, slabs were compared directly after production with a closed surface (C1) and after removal of the surface material by planing (C2). Slotted slabs are produced either by material removal by means of corresponding molds in the bead foaming process (C3) or by material-removing processing by means of circular saws from slabs (C4). In each case, the slot separation in longitudinal and transverse direction is 30 mm. The slots are introduced only on one side of the slab with a slot width of 2 mm and a slot depth of 19 mm (slab thickness of 20 mm).

To determine the resin absorption, as well as the resin systems used, the foam slabs and glass rovings, the following auxiliary materials are used: nylon vacuum film, vacuum sealing tape, nylon flow aid, polyolefin separation film, polyester tearoff fabric and PTFE membrane film and polyester absorption fleece. Panels, also referred to hereinafter as sandwich materials, are produced from the moldings by applying fiber-reinforced outer plies by means of vacuum infusion. Two plies of Quadrax glass rovings (E glass SE1500, OCV; textile: Saertex, isotropic laminate [0°/−45°/90° 45°] with 1200 g/m² in each case) each are applied to the upper and lower sides of the (fiber-reinforced) foams. For the determination of the resin absorption, a separation film is inserted between the molding, also referred to hereinafter as core material, and the glass rovings, in contrast with the standard production of the panels. In this way, the resin absorption of the pure molding is determinable. The tearoff fabric and the flow aids are mounted on either side of the glass rovings. The construction is subsequently equipped with gates for the resin system and gates for the evacuation. Finally, a vacuum film is applied over the entire construction and sealed with sealing tape, and the entire construction is evacuated. The construction is prepared with a glass surface on an electrically heatable stage.

The resin system used is an amine-curing epoxide (resin: BASF Baxxores 5400, curing agent: BASF Baxxodur 5440, mixing ratio and further processing according to data sheet). After the two components have been mixed, the resin is evacuated at down to 20 mbar for 10 minutes. At a resin temperature of 23+/−2° C., infusion is effected onto the preheated structure (stage temperature: 35° C.). By means of a subsequent temperature ramp of 0.3 K/min from 35° C. to 75° C. and isothermal curing at 75° C. for 6 h, it is possible to produce panels consisting of the moldings and glass fiber-reinforced outer plies.

At the start, the moldings are analyzed according to ISO 845 (October 2009 version), in order to obtain the apparent density of the foam. After the resin system has cured, the processed panels are trimmed in order to eliminate excess resin accumulations in the edge regions as a result of imperfectly fitting vacuum film. Subsequently, the outer plies are removed and the moldings present are analyzed again by ISO 845. The difference in the densities gives the absolute resin absorption. Multiplication by the thickness of the molding then gives the corresponding resin absorption in kg/m².

The results shown (see table 1) demonstrate that it is possible to distinctly reduce resin absorption in the case of moldings made from molded foams. The result is consequently a reduced density of the panel.

TABLE 1

| | | Closed | Resin |
|---|---|---|---|
| Example | Material | surface | absorption |
| C1 | Slab directly after processing (closed | >90% | <0.2 kg/m² |
| | surface) | | |
| C2 | Slab after removal of surface material | <5% | 0.4 kg/m² |
| C3 | Slotted slab directly after processing | >90% | 3.3 kg/m² |
| C4 | Slotted slab by material-removing | <5% | 3.8 kg/m² |
| | processing | | |

### EXAMPLE 2 (MOLDING MADE FROM EXPANDED BEAD FOAM WITH FIBER REINFORCEMENT)

In order to improve peel resistance with simultaneously low resin absorption at the surface, the experiments from example 1 are repeated, except that the molding (expanded bead foam) is first partly reinforced with glass fibers (rovings, S2 glass, 400 tex, AGY).

The glass fibers are introduced in the form of rovings at an angle α of 45° in four different spatial directions at an angle β to one another (0°, 90°, 180°, 270°). An identical number of glass fibers is introduced in all spatial directions. The glass fibers are introduced in a regular rectangular pattern with equal distances (a). In the experiments, the distance is varied from a=10 mm up to a=20 mm. On both sides, about 10 mm of the glass fibers have additionally been left as excess at the outer ply, in order to improve the binding to the glass fiber mats that will be introduced later as outer plies. The fibers or fiber rovings are introduced in an automated manner by a combined needle/hook process. First of all, a hook needle (diameter of about 0.80 mm) is used to penetrate completely from the first side to the second side of the molded foam. On the second side, a roving is hooked into the hook of the hook needle and then pulled from the second side by the needle back to the first side of the molded foam. Finally, the roving is cut off on the second side and the roving loop formed is cut open at the needle. The hook needle is thus ready for the next operation. A total of 40 000 reinforcing glass fiber elements (rovings)/m² at a distance of 10 mm and 10 000 glass fiber elements/m² in a pattern of aₓ=a_{y}=20 mm were introduced.

Subsequently, panels were produced from the moldings by application of fiber-reinforced outer plies by means of vacuum infusion as described above for example 1. In contrast to example 1, no separation film is introduced between the molding and the glass rovings.

The peel resistance of the panels is determined with single cantilever beam (SCB) samples. The molding height of the samples is 20 mm; the outer layers each consist of quasi-isotropic glass fiber-reinforced epoxy resin layers of thickness about 2 mm. The samples are tested in a Zwick Z050 tensile tester at a speed of 5 mm/min, with application of the load to each specimen and removal thereof in a repeated manner (3 to 4 times). The growth in cracking or the increase is assessed visually in each load cycle (Δa). The force-distance plot is used to ascertain the crack growth energy (ΔU). This is used to ascertain the tear strength or peel resistance determined as

$${G}_{IC} = \frac{Δ U}{B Δ a}$$

with B as the sample width.

TABLE 2

| | Material, angle α, | | Resin absorption |
|---|---|---|---|
| Example | distances aₓ × a_{y} | Peel resistance | through surface |
| C1 | unplaned foam | 0.7 kJ/m² | <0.2 kg/m² |
| C2 | planed foam | 0.8 kJ/m² | 0.4 kg/m² |
| I5 | C1, fiber reinforced at | 1.3 kJ/m² | <0.2 kg/m² |
| | 45°/20 mm × 20 mm | | |
| I6 | C1, fiber reinforced at | 3.5 kJ/m² | <0.2 kg/m² |
| | 45°/12 mm × 12 mm | | |
| I7 | C1, fiber reinforced at | 6.9 kJ/m² | <0.2 kg/m² |
| | 45°/10 mm × 10 mm | | |
| I8 | C2, fiber reinforced at | 1.4 kJ/m² | 0.4 kg/m² |
| | 45°/20 mm × 20 mm | | |

As is clearly apparent from table 2, it is possible by means of the moldings of the invention with integrated fibers which comprise an expanded bead foam to distinctly increase peel resistance in a panel (15 to 18). The improvement in peel resistance by planing of the surface, by contrast, enables only moderate increases in peel resistance and is simultaneously associated with elevated resin absorption (C2). The fiber reinforcement of the molded foam thus permits a distinct increase in peel resistance with virtually identical resin absorption of the surface. Specifically, the strength depends only slightly on the surface roughness or pre-treatment and hence enables decoupling of the two optimization aims of peel strength and resin absorption.

### EXAMPLE 3 (DESIGN OF A PANEL FOR ILLUSTRATION OF THE PREFERRED FIBER ANGLES, THEORETICAL DETERMINATION)

The mechanical properties of a molding comprising an expanded bead foam according to example C1 were determined theoretically. The fibers (F) used were glass fibers (rovings, S2 glass, 406 tex, AGY). The angle α at which the fibers (F) were assumed to have been introduced was in the range from 0° to 80°. At angles α>0°, the fibers were assumed to be in four different spatial directions at the angle β (0°, 90°, 180°, 270°) to one another. Regular patterns with equal distances a=12 mm and, at an angle α of 0°, 27 778 glass fiber elements/m² were assumed.

The shear moduli were calculated for different angles α. For this purpose, a strut and tie model with flexible struts was used for connection of the upper and lower outer layers. The outer layers were assumed to be infinitely stiff. The expanded bead foam had a thickness of 25 mm, a shear stiffness G=19 MPa, and a compression stiffness E=35 MPa. The resin absorption at the surface of the foam was assumed to be 0.2 kg/m² (conservative estimate, since <0.2 kg/m² in experiments).

The fiber bundles consist of S glass fibers. As a result of the manufacturing process, the reinforcing elements had a thickness of 2×406 tex (=812 tex); the fiber volume content was assumed to be 40% by volume and the diameter to be 1.0 mm. This gives rise to the figures reported in table 3 for shear moduli, densities of the molding in the processed panel and specific shear moduli.

TABLE 3

| | | | Density of the | Specific shear |
|---|---|---|---|---|
| | Angle α | Shear modulus | molding | moduli |
| Example | (°) | (MPa) | (kg/m³) | (MPa/(kg/m³) |
| C9 | 0 | 14 | 127 | 0.11 |
| I10 | 10 | 25 | 128 | 0.20 |
| I11 | 20 | 53 | 131 | 0.41 |
| I12 | 30 | 91 | 135 | 0.67 |
| I13 | 40 | 127 | 144 | 0.88 |
| I14 | 45 | 140 | 150 | 0.94 |
| I15 | 50 | 148 | 157 | 0.94 |
| I16 | 60 | 147 | 182 | 0.81 |
| I17 | 70 | 121 | 232 | 0.52 |
| C18 | 80 | 74 | 388 | 0.19 |

It is clearly apparent that shear stiffness increases rapidly with rising fiber angle before dropping again over and above about 60°.

For the use of the panels, flexural stiffness or blister resistance is generally very important. The blister stiffness of a panel with parallel symmetric; outer layers can be determined as follows with standard force introduced at the end:

$$F \geq \frac{{π}^{2} D}{( {t}^{2} + \frac{{π}^{2} Dt}{{Gd}^{2}} )} b$$

where F is the force before occurrence of global blistering (=blister resistance), D is the flexural stiffness of the panel, G is the shear modulus of the molding (=core material), t is the thickness of the molding of the panel, b is the width of the panel and d is the thickness of the molding (=core material) plus one outer layer thickness.

The flexural stiffness of the panel is calculated from:

$$D = \frac{{E}_{D} {t}_{D}^{3}}{6} + \frac{{E}_{D} {t}_{D} {d}^{2}}{2} + \frac{{E}_{K} {t}_{K}^{2}}{12}$$

E_{D} is the modulus of elasticity of the outer layer, E_{K} is the modulus of elasticity of the molding (=core material), t_{D} is the thickness of the outer layer per side, tₖ is the thickness of the molding (=core material), d is the thickness of the core material plus the thickness of one outer layer.

The width of the panel was assumed to be 0.1 m; the length was 0.4 m. The thickness of the molding was 25 mm, the thickness of the outer layer 2 mm, and the modulus of elasticity of the outer layer 39 GPa.

The moldings used were the moldings according to examples C9 to C18.

The results are reported in table 4.

TABLE 4

| | | Density of the | Blister | Specific blister |
|---|---|---|---|---|
| | Angle α | molding | stability | stability |
| Example | (°) | (kg/m³) | (kN) | (kN/(kg/m³) |
| C19 | 0 | 127 | 30 | 0.24 |
| I20 | 10 | 128 | 47 | 0.36 |
| I21 | 20 | 131 | 77 | 0.59 |
| I22 | 30 | 135 | 101 | 0.74 |
| I23 | 40 | 144 | 114 | 0.80 |
| I24 | 45 | 150 | 118 | 0.79 |
| I25 | 50 | 157 | 120 | 0.76 |
| I26 | 60 | 182 | 120 | 0.66 |
| I27 | 70 | 232 | 112 | 0.48 |
| C28 | 80 | 388 | 90 | 0.23 |

It is clearly apparent that blister stability increases rapidly with rising angle α before dropping again over and above about 60°.

1.-16. (canceled)

17. A molding made of expanded bead foam, wherein at least one fiber (F) is present with a fiber region (FB2) within the molding and is surrounded by the expanded bead foam, while a fiber region (FB1) of the fiber (F) projects from a first side of the molding and a fiber region (FB3) of the fiber projects from a second side of the molding, where the fiber (F) has been introduced into the expanded bead foam at an angle α of 10° to 70° relative to the thickness direction (d) of the molding.

18. The molding according to claim 17, wherein the expanded bead foam is based on at least one polymer selected from polystyrene, polyphenylene oxide, a copolymer prepared from phenylene oxide, a copolymer prepared from styrene, polysulfone, polyether sulfone, polypropylene, polyethylene, polyamide, polycarbonate, polyacrylate, polylactic acid, polyimide, polyvinylidene difluoride or a mixture thereof.

19. The molding according to claim 17, wherein
i) the fiber (F) is a single fiber or a fiber bundle, or
ii) the fiber (F) is an organic, inorganic, metallic or ceramic fiber, or
iii) the fiber (F) is used in the form of a fiber bundle having a number of single fibers per bundle of at least 10, in the case of glass fibers and 1000 to 50 000 in the case of carbon fibers, or
iv) the fiber region (FB1) and the fiber region (FB3) each independently account for 1% to 45%, and the fiber region (FB2) for 10% to 98% of the total length of a fiber (F).

20. The molding according to claim 17, wherein
i) the fiber (F) has been introduced into the expanded bead foam at an angle α of 30° to 60°, relative to the thickness direction (d) of the molding, or
ii) in the molding, the first side of the molding from which the fiber region (FB1) of the fibers (F) projects is opposite the second side of the molding from which the fiber region (FB3) of the fibers (F) projects, or
iii) the molding comprises a multitude of fibers (F), or comprises more than 10 fibers (F) or fiber bundles per m².

21. The molding according to claim 17, wherein the expanded bead foam of the molding is produced by a process comprising the following steps I) to VI):
I) producing expandable polymer beads from the corresponding polymer in the presence of a blowing agent at elevated temperature,
II) optionally cooling or expanding the blowing agent-laden expandable polymer beads, optionally with expansion of the polymer beads to partly expanded polymer beads,
III) optionally performing a pelletization of the expandable polymer beads,
IV) optionally prefoaming the expandable polymer beads and or optionally the partly expanded polymer beads at elevated temperature in the range from 95 to 150° C., or at low pressures in the range from 1 to 5 bar, in the presence of steam or of a steam/air mixture, to obtain expanded beads,
V) introducing the partly expanded polymer beads from step II) or the pelletized beads from step III) or the expanded beads from step IV) into a shaping mold,
VI) contacting the partly expanded polymer beads from step II) or the pelletized beads from step III) or the expanded beads from step IV) with steam at elevated pressure in the range from 1 to 25 bar, or elevated temperature in the range from 100 to 220° C., in the shaping mold to obtain the moldings made of expanded bead foam.

22. The molding according to claim 21, characterized in that the beads for production of the expanded bead foam of the molding have been produced by a suspension process, a melt impregnation process, a melt expansion process or a tank expansion process.

23. The molding according to claim 17, wherein
i) the surface of at least one side of the molding has at least one recess, or
ii) the total surface area of the molding is closed to an extent of more than 30%.

24. A panel comprising at least one molding according to claim 17 and at least one layer (S1).

25. The panel according to claim 24, wherein the layer (S1) comprises at least one resin.

26. The panel according to claim 26, wherein the resin being based on epoxides, acrylates, polyurethanes, polyamides, polyesters, unsaturated polyesters, vinyl esters or mixtures thereof.

27. The panel according to claim 24, wherein the layer (S1) additionally comprises at least one fibrous material, where)
i) the fibrous material comprises fibers in the form of one or more laminas of chopped fibers, webs, scrims, knits or wovens, or
ii) the fibrous material comprises organic, inorganic, metallic or ceramic fibers.

28. The panel according to claim 24, wherein the panel has two layers (S1) and the two layers (S1) are each mounted on a side of the molding opposite the respective other layer in the molding.

29. The panel according to claim 24, wherein
i) the fiber region (FB1) of the fiber (F) is in partial or complete contact, with the first layer (S1), or
ii) the fiber region (FB3) of the fiber (F) is in partial or complete contact, with the second layer (S1), or
iii) the panel has at least one layer (S2) between at least one side of the molding and at least one layer (S1).

30. The panel according to claim 29, wherein the layer (S2) being composed of two-dimensional fiber materials or polymeric films.

31. A process for producing a molding according to claim 17, which comprises partly introducing at least one fiber (F) into the expanded bead foam, as a result of which the fiber (F) is present with the fiber region (FB2) within the molding and is surrounded by the expanded bead foam, while the fiber region (FB1) of the fiber (F) projects out of a first side of the molding and the fiber region (FB3) of the fiber (F) projects out of a second side of the molding, as a result of which the fiber (F) has been introduced into the expanded bead foam at an angle α of 10° to 70° relative to the thickness direction (d) of the molding.

32. The process according to claim 31, wherein the at least one fiber (F) is partially introduced into the expanded bead foam by sewing it in using a needle.

33. The process according to claim 32, wherein the partial introduction being effected by means of steps a) to f):
a) optionally applying at least one layer (S2) to at least one side of the expanded bead foam,
b) producing one hole per fiber (F) in the expanded bead foam and in any layer (S2), the hole extending from a first side to a second side of the expanded bead foam and through any layer (S2),
c) providing at least one fiber (F) on the second side of the expanded bead foam,
d) passing a needle from the first side of the expanded bead foam through the hole to the second side of the expanded bead foam, and passing the needle through any layer (S2),
e) securing at least one fiber (F) on the needle on the second side of the expanded bead foam, and
f) returning the needle along with the fiber (F) through the hole, such that the fiber (F) is present with the fiber region (FB2) within the molding and is surrounded by the expanded bead foam, while the fiber region (FB1) of the fiber (F) projects from a first side of the molding or from any layer (S2) and the fiber region (FB3) of the fiber (F) projects from a second side of the molding.

34. The process according to claim 33 with simultaneous performance of steps b) and d).
